(19) United States
(12) Patent Application Publication
(10) Pub. No.: US 2023/0235722 A1
(43) Pub. Date: Jul. 27, 2023

(54) METHOD FOR REDUCING THE NOISE EMISSION OF A WIND TURBINE ROTOR BLADE AND WIND TURBINE ROTOR BLADE

(71) Applicant: Wobben Properties GmbH, Aurich (DE)

(72) Inventors: Tanja Stüttchen, Oldenburg (DE); Andre Kubasik, Aurich (DE); Jochen Stemberg, Aurich (DE)

(21) Appl. No.: 18/158,846

(22) Filed: Jan. 24, 2023

(30) Foreign Application Priority Data
Jan. 27, 2022 (EP) 22153587.5

(51) Int. Cl. F03D 1/06

(52) U.S. Cl. CPC F03D 1/0633; F05B 2230/90; F05B 2240/305; F05B 2260/96

(57) ABSTRACT

A method is provided for reducing the noise emission of a wind turbine rotor blade. The rotor blade has a leading edge, a trailing edge, a suction side, a pressure side and an attachment part at least partially on the pressure side. A pressure-side transition is present between the pressure side and the attachment part. The pressure-side transition is leveled by applying a leveling compound.

### BACKGROUND

### Technical Field

The present invention relates to a method for reducing the noise emission of a wind turbine rotor blade and a wind turbine rotor blade.

### Description of the Related Art

In order to reduce the noise emission of a wind turbine rotor blade during operation of the rotor blade, an attachment part, e.g., a trailing edge comb (serration), can be fastened or adhesively bonded to a trailing edge of a rotor blade.

### BRIEF SUMMARY

One or more embodiments of the present invention is directed to reducing the noise emission of a wind turbine rotor blade during operation.

Thus provided is a method for reducing the noise emission of a wind turbine rotor blade during operation of the rotor blade. The rotor blade has a rotor blade root, a rotor blade tip, a leading edge, a trailing edge, a suction side, and a pressure side. An attachment part or attachment element can be provided in the area of the pressure side, and in particular in the area of the trailing edge. For example, at least one trailing edge comb with a plurality of teeth can be provided on the trailing edge. Further present is a first transition between the suction side and the attachment part, as well as a second transition between the pressure side and the attachment part. The transition between the pressure side and the attachment part is filled with a leveling compound. The attachment part can be configured as a trailing edge comb.

According to an aspect of the present invention, a spatula is applied against a surface of the pressure side, and covers the pressure-side (second) transition, and in particular a step on the pressure-side (second) transition. The point on a pressure side of the attachment part (e.g., of the trailing edge comb) against which the free end of the spatula abuts is marked, and describes the area up to which the leveling compound is to be applied. As a consequence, the leveling compound can be provided in such a way that the surface of the pressure side can be lengthened without a transition or step.

According to an aspect of the present invention, a first adhesive tape can be provided at the transition between the suction side and the attachment part (e.g., a trailing edge comb). A second adhesive tape can further be provided on the surface of the pressure side adjacent to the transition. A third adhesive tape can be provided in the area of the marking. A leveling compound can be applied between the second and third adhesive tape.

According to another aspect, a leveling material can be provided in the form of an adhesive bead in the area of the transition, for example. The material can then be distributed by means of a spatula. All adhesive tapes can subsequently be removed, thereby resulting in a rotor blade that has a transition between a pressure side and an attachment part (e.g., a trailing edge comb), which has been leveled by a leveling material, so that a lengthened surface of the pressure side is provided in the area of the leveling material.

The pressure-side (second) transition can be present in the form of an edge, step, sink, recess, or cutout. The pressure-side (second) transition can be leveled by applying the leveling compound. Such a transition can have a negative effect within a frequency range starting at 800 Hz. As a result, the approved sound level can be exceeded.

According to an aspect of the invention, the attachment part can consist of a trailing edge comb, brushes, flat panels, porous flat panels, curved panels, curved serrations or the like.

According to an aspect of the present invention, a wind turbine rotor blade is provided with a leading edge, a trailing edge, a suction side, a pressure side, and an attachment part at least partially on the pressure side. A pressure-side transition between the pressure side and the attachment part is present, and leveled by applying a leveling compound.

According to an aspect of the present invention, a recess or a protrusion is provided in the area of the pressure-side transition, and the leveling compound is applied in the area of the pressure-side transition and in the area of the recess or the step.

Additional configurations of the invention are the subject of the subclaims.

### BRIEF DESCRIPTION OF THE SEVERAL VIEWS OF THE DRAWINGS

Advantages and exemplary embodiments of the invention will be described in more detail below with reference to the drawing.

FIG. 1 shows a schematic view of a wind turbine according to an aspect of the present invention,

FIG. 2 shows a view of a cross section of a rotor blade according to an aspect of the present invention,

FIG. 3 to FIG. 8 each show a schematic cross section of a rotor blade of a wind turbine when applying a leveling material onto a pressure side of the rotor blade according to an aspect of the present invention, and

FIG. 9 shows a schematic cross section of a rotor blade according to another exemplary embodiment.

### DETAILED DESCRIPTION

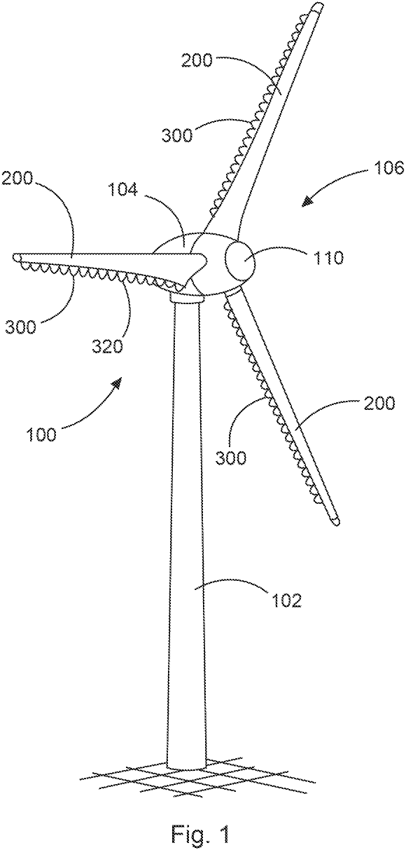

FIG. 1 shows a schematic view of a wind turbine according to an aspect of the present invention. The wind turbine 100 has a tower 102 and a nacelle 104 on the tower 102. Provided on the nacelle 104 is an aerodynamic rotor 106 with three rotor blades 200 and a spinner 110. During operation of the wind turbine, the aerodynamic rotor 106 is made to rotate by the wind, and thus also rotates a rotor or runner of a generator, which is directly or indirectly coupled with the aerodynamic rotor 106. The electric generator is arranged in the nacelle 104, and generates electrical energy. The pitch angles of the rotor blades 200 can be changed by pitch motors on the rotor blade roots 210 of the respective rotor blades 200.

The rotor blade 200 has a rotor blade root 210, a rotor blade tip 220, a rotor blade leading edge 230, a rotor blade trailing edge 240, a suction side 250 and a pressure side 260. The trailing edge 240 can be provided at least partially with an attachment part 300, e.g., a trailing edge comb 300 with a plurality of teeth 320.

The attachment part 300 can also be provided not on the trailing edge 240, but rather at least partially on the pressure side 260.

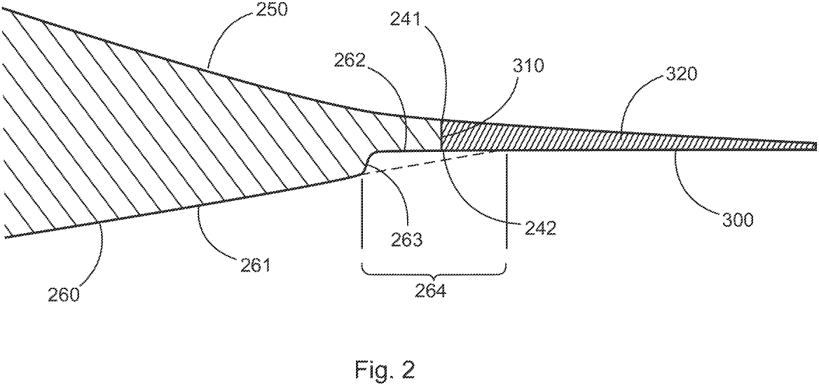

FIG. 2 shows a view of a cross section of a rotor blade according to an aspect of the present invention. The rotor blade on FIG. 2 can correspond to a rotor blade according to FIG. 1. An attachment part 300, e.g., in the form of a trailing edge comb 300, can be fastened to the trailing edge 240 of the rotor blade 200. It is here possible to provide a first (suction-side) transition 241 between the suction side 250 and the attachment part 300 (e.g., a trailing edge comb) as well a second (pressure-side) transition 242 between a pressure side 260 and the attachment part 300 (e.g., a trailing edge comb). The second transition 242 can have a setback 263 or a protrusion 263. As a consequence, for example, the thickness of the tailing edge 240 (abruptly) decreases or increases in the direction of the trailing edge.

While examining a rotor blade according to the invention, it was found that the pressure-side (second) transition on the pressure side has an unexpectedly negative effect on the noise emission of the rotor blade during operation. Until now, it had been assumed that only such a transition on the suction side had a negative effect on noise emission.

According to an aspect of the invention, the pressure side 200 has a surface 261, which can essentially be straight in the area of the trailing edge 240. A regression or a step 262 can be provided in the area of the second transition 242, and must be leveled by a leveling compound 400.

According to an aspect of the invention, a leveling compound is provided in the area of the second transition between the pressure side and trailing edge comb, so as to level the second transition. This leads to a significant reduction in the noise emissions produced during operation of the rotor blade.

The second transition 242 can optionally have a regression or a recess 262 with a step 263 and a length 264.

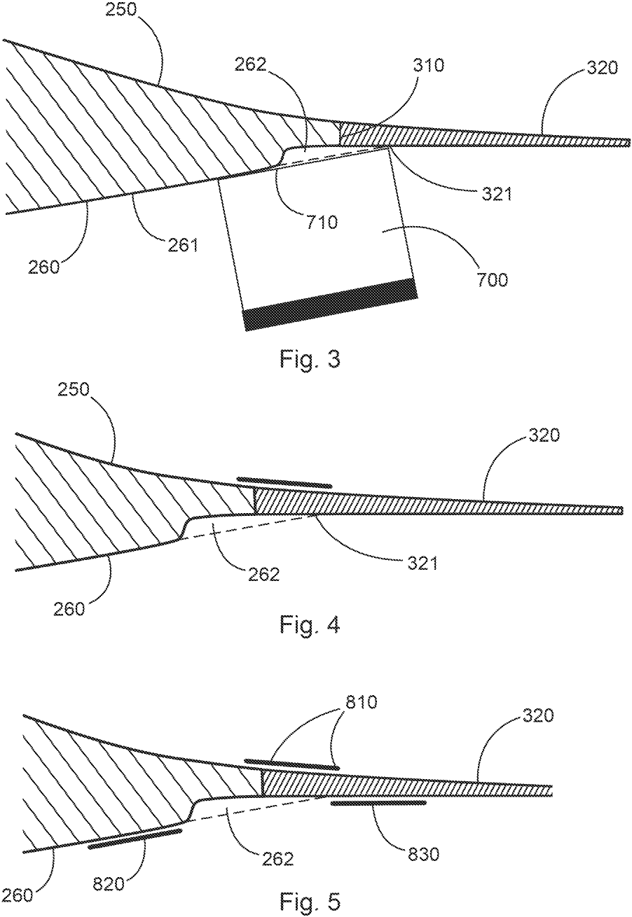

FIG. 3 to FIG. 8 show a schematic cross section of a rotor blade of a wind turbine during the application of a leveling material to the pressure side of the rotor blade according to one aspect of the present invention. The rotor blade 200 has a suction side 250, a pressure side 260, a trailing edge 240 as well as an attachment part, e.g., in the form of a trailing edge comb 300. The pressure side 260 has a surface 261 that can essentially be straight in the area of the trailing edge 240. A first suction-side transition 241 can be provided between the suction side 250 and the trailing edge comb 300, and a second pressure-side transition 242 can be provided between the pressure side 260 and the trailing edge comb 300. A regression 262 in the material of the rotor blade in the area of the trailing edge 240 can be provided in the area of the second transition 242, which must be leveled by a leveling compound. The second transition 242 can have a regression or a recess 262 with a step 263 and a length 264 in the material of the rotor blade. A spatula 700 with a first straight end 710 can be provided for leveling the regression or in the transition 262. The spatula 700 can here be placed in the area of the second transition 242 in such a way that the end 210 abuts both against a surface 261 of the pressure side and against a pressure side of the trailing edge comb. As evident on FIG. 3, the surface to be leveled is thereby — cross sectionally — bordered by the regression 262 and the end 710 of the spatula 700. The point of contact between the end 710 and the pressure side of the trailing edge comb can optionally be provided with a marking 321. As a consequence, the point to which the leveling compound 400 is to be applied can be determined. This is intended to level the transition between the pressure side 260 and the trailing edge comb 300.

As visible on FIG. 4, a first adhesive tape 810 can for this purpose be provided in the area of the first transition 241 between the suction side 250 and the trailing edge comb 300, for example.

As evident on FIG. 5, a second adhesive tape 820 can be provided on the pressure side 260 adjacent to the second transition 242. A third adhesive tape 830 can be provided in the area of the marking 321.

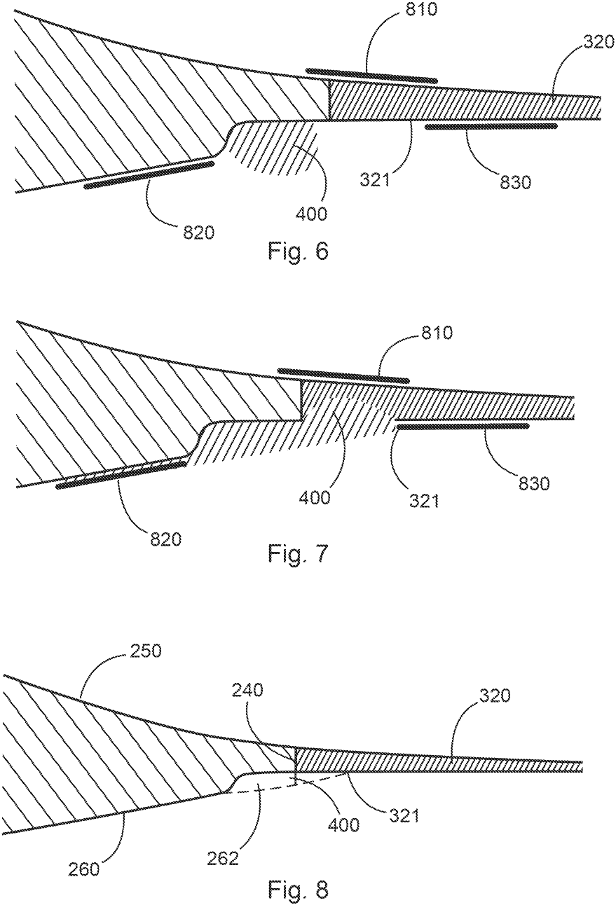

As shown on FIG. 6, a leveling material 400 can subsequently be applied, for example in the form of an adhesive bead. The material 400 can then be applied and distributed between the adhesive tapes 820, 830 by means of a spatula 700, for example.

The final result is then visible on FIG. 8. The surface of the leveling material is here then adjusted to the surface 261 of the pressure side 260 of the rotor blade in the area of the trailing edge.

The second transition 242 has been leveled by the leveling compound.

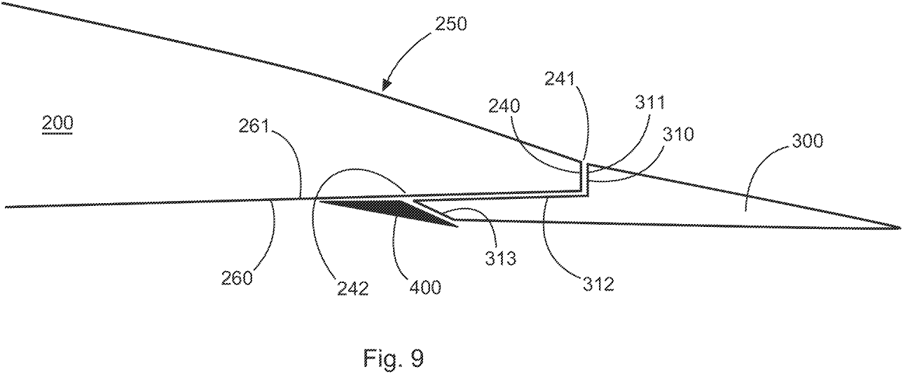

FIG. 9 shows a schematic cross section of a rotor blade according to another exemplary embodiment of the invention. The rotor blade according to FIG. 9 can here correspond to the rotor blade according to FIG. 2. The rotor blade 200 has a suction side 250 and a pressure side 260 with a surface 261. The rotor blade 200 further has a trailing edge 240. An attachment part 300 can be provided in the area of the trailing edge 240, for example in the form of a trailing edge comb 300. While a recess is present in the area of the pressure side 260 of the rotor blade according to the exemplary embodiment on FIG. 2, such a recess is not present in the rotor blade according to FIG. 9. A first suction-side transition 241 is provided in the area of the suction side 250 and the attachment part 300. A second pressure-side transition is provided between the pressure side 260 and the attachment part 300. According to the exemplary embodiment on FIG. 9, the attachment part 300 has a first end 310 with a first, second and third section 311, 312, 313. The second and third sections 312, 313 here extend at least partially along the surface 261 of the pressure side 260. As a consequence, a step or a protrusion 313 is present in the area of the second pressure-side transition 242 between the pressure side 260 and the attachment part 300. This protrusion 313 has a negative effect on the aerodynamic properties of the rotor blade 200, and in particular on the acoustic properties of the rotor blade. Similarly to the exemplary embodiment on FIG. 3 to FIG. 8, a leveling compound 400 is thus provided in the area of the second pressure-side transition 242, so as to obtain an aerodynamically more favorable transition.

According to an aspect of the invention, the attachment part 300 can consist of a trailing edge comb, brushes, flat plates, porous flat plates, curved plates, curved serrations or the like. The decisive factor here is that a recess (as on FIG. 3) or a protrusion (as on FIG. 9) be present on the pressure side, so that an aerodynamically unfavorable transition is present.

According to an aspect of the present invention, a leveling compound 400 is used to process the aerodynamically unfavorable transition, so as to obtain an aerodynamically more favorable transition.

REFERENCE LIST

| | |
|---|---|
| 100 | Wind turbine |
| 102 | Tower |
| 104 | Nacelle |
| 106 | Aerodynamic rotor |
| 110 | Spinner |
| 200 | Rotor blades |
| 200 b | Rotor blades roots |
| 210 | Rotor blades root |
| 220 | Rotor blades tip |
| 230 | Rotor blades leading edge |
| 240 | Rotor blades trailing edge |
| 241 | First transition |
| 242 | Second transition |
| 250 | Suction side |
| 260 | Pressure side |
| 261 | Surface |
| 262 | Regression |
| 263 | Step |
| 264 | Leveling length |
| 300 | Attachment part |
| 310 | First end |
| 311 | First section |
| 312 | Second section |
| 313 | Third section |
| 320 | Teeth |
| 321 | Marking |
| 400 | Adhesive/leveling compound |
| 700 | Spatula |
| 710 | First end |
| 810 | First adhesive tape |
| 820 | Second adhesive tape |
| 830 | Third adhesive tape |

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
reducing noise emission of a wind turbine rotor blade, wherein the wind turbine rotor blade has a leading edge, a trailing edge, a suction side, a pressure side, and an attachment part located at least partially on the pressure side,
wherein the wind turbine rotor blade has a pressure-side transition between the pressure side and the attachment part, wherein the reducing comprises leveling the pressure-side transition by applying a leveling compound.

2. The method according to claim 1, wherein the attachment part is a trailing edge comb, wherein the wind turbine rotor blade has a suction-side transition between the suction side and the trailing edge comb.

3. The method according to claim 2, wherein leveling the pressure-side transition comprises using a spatula to apply the leveling compound against a surface of the pressure side in such a way that an area on one pressure side of the trailing edge comb, against which the free end of the spatula abuts, represents an area up to which the leveling compound is applied.

4. The method according to claim 1, wherein the wind turbine rotor blade has a recess in an area of the pressure-side transition in a material of the rotor blade on the pressure side of the trailing edge.

5. The method according to claim 4, wherein the recess forms a step.

6. The method according to claim 4, wherein a first adhesive tape is on the pressure-side transition between the suction side and the trailing edge comb, and
wherein a second adhesive tape is on the surface of the pressure side adjacent to the second transition, and wherein a third adhesive tape is in an area of the leveling compound.

7. The method according to claim 1, wherein a leveling material is applied in an area of the pressure-side transition and distributed using a spatula.

8. The method according to claim 1, wherein the attachment part is at least partially arranged on the pressure side,
wherein the attachment part has a first end,
wherein a protrusion or a step is present in an area of the pressure-side transition between the pressure side and the first end of the attachment part, and
wherein the leveling compound is applied in the area of the pressure-side transition.

9. A wind turbine rotor blade, comprising:
a leading edge,
a trailing edge,
a suction side,
a pressure side,
an attachment part at least partially on the pressure side,
a pressure-side transition between the pressure side and the attachment part, and
a leveling compound in an area of the pressure-side transition.

10. The wind turbine rotor blade according to claim 9, wherein the leveling compound is located in a recess at the area of the pressure-side transition.

11. The wind turbine rotor blade according to claim 9, wherein a protrusion or a step is between the pressure side and a first end of the attachment part in the area of the pressure-side transition, wherein the leveling compound is in the area of the pressure-side transition.
